(19) United States
(12) Patent Application Publication
(10) Pub. No.: US 2010/0051719 A1
(43) Pub. Date: Mar. 4, 2010

(54) SHOWER HEAD DISPENSER

(76) Inventors: Vito James CARLUCCI, Stratford, CT (US); Harold Roy Taylor, Stratford, CT (US); Paul J. Carrubba, Baldwin, NY (US)

Correspondence Address: Lawrence Cruz;Conair Corporation, One Cummings Point Road, STAMFORD, CT, 06902, US

(21) Appl. No.: 12/200,501

(22) Filed: Aug. 28, 2008

(51) Int. Cl. B05B 7/28

(52) U.S. Cl. 239/316

(57) ABSTRACT

A soap dispensing shower head assembly comprises a pipe fitting 3 having internal threads 2 attaching directly to a shower faucet pipe 1. A fitting ring 5 is rotatably mounted on the pipe fitting 3 and head internal threads 4 so that the fitting ring 5 may be attached to an externally threaded portion 6 of the bottle bracket 7. First and second water conduits 11, 13 are in communication with a diverter valve 9 so that incoming water from the faucet pipe 1 is directed through the first conduit 11 and through the diverter valve 9, and back up through the second conduit 13. The diverter valve 9 is manually operable via a knob 37 and can be positioned to direct water through the second conduit 13 to the soap and water mixing chamber 15 in the pivoting shower head 17. The soap and water mixture stream then exits the shower head 17 through outlet nozzles 18.

### CROSS-REFERENCE TO RELATED APPLICATIONS

None.

### BACKGROUND OF THE INVENTION

The present invention relates to shower heads and, more particularly, to shower heads having additional components for dispensing a liquid or gel such as a soap or conditioning lotion.

### DESCRIPTION OF RELATED ART

Various shower heads exist for emitting pressurized water from a plumbing system in a building. Certain shower heads include one or more means for attaching a container holding a liquid, or a solid to be dissolved in a liquid, which is selectively injected into or mixed with a water stream being emitted from the shower head. Such known designs require a user to fill a dedicated container with the liquid or product to be injected into or mixed with the water stream. It is desirable to provide a novel design for a shower head that has improved convenience and functionality in view of known designs.

### OBJECT OF THE PRESENT INVENTION

It is an object of the present invention to provide a shower head having a dispensing component for injecting or mixing a product or substance with a water stream emitted from the shower head that overcomes the limits and shortcomings of known designs.

These an other objects are achieved by the present invention disclosed herein.

### SUMMARY OF THE INVENTION

According to the present invention, a shower head comprises a water inlet port, an internal chamber, a plurality of water outlet nozzle openings, a holding area to hold a container of product such as soap or conditioner, a lever to activate a pump to draw the product from the container, and a series of conduits and at least one valve to selectively control the flow of product to mix with water to be emitted from the shower head.

### BRIEF DESCRIPTION OF THE DRAWINGS

FIG. 1 is a side, cross-sectional view of a first preferred embodiment of the present invention showing a first mode of operation.

FIG. 2 is a partial, side, cross-sectional view of a first preferred embodiment of the present invention.

FIG. 3 is a front view of a first preferred embodiment of the present invention.

FIG. 4 is a side view of a first preferred embodiment of the present invention.

FIG. 5 is a rear view of a first preferred embodiment of the present invention.

FIG. 6 is a side, cross-sectional view of a second preferred embodiment of the present invention showing a second mode of operation.

FIG. 7 is a side, cross-sectional view of a second preferred embodiment of the present invention showing a third mode of operation.

FIG. 8 is a side, cross-sectional view of a second preferred embodiment of the present invention showing a fourth mode of operation.

FIG. 9 is a partial, side, cross-sectional view of a third preferred embodiment of the present invention showing a first mode of operation.

### DESCRIPTION OF THE PREFERRED EMBODIMENTS OF THE PRESENT INVENTION

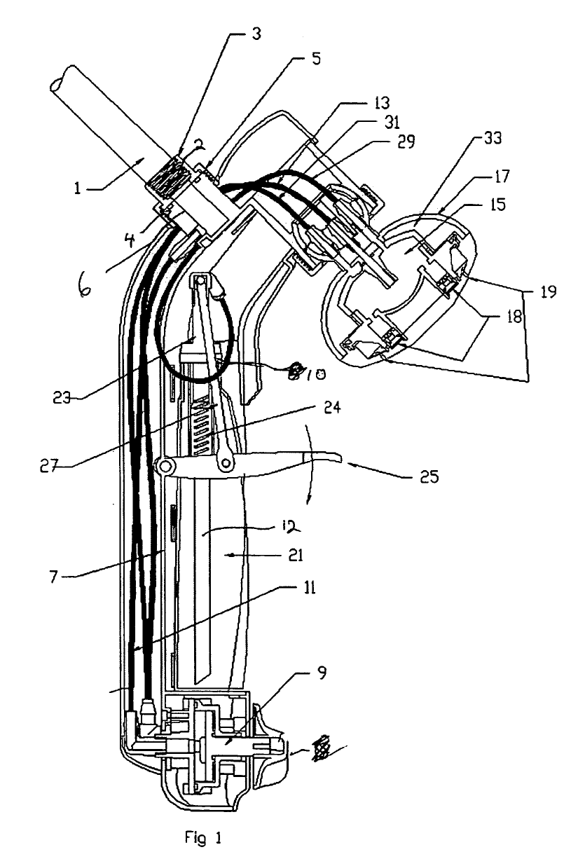

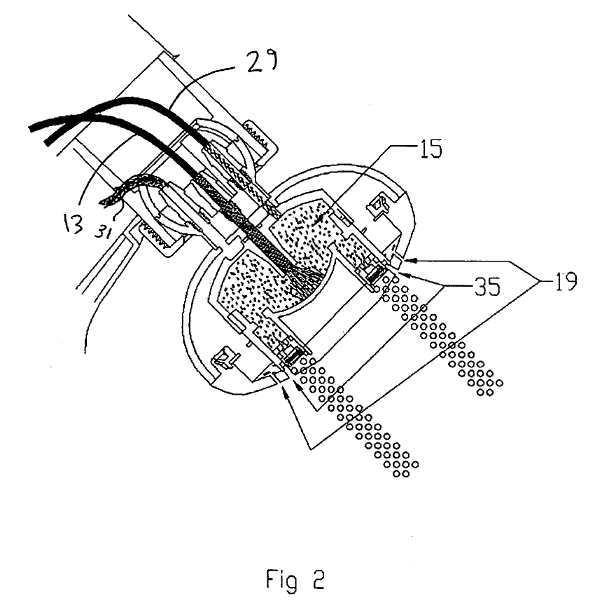

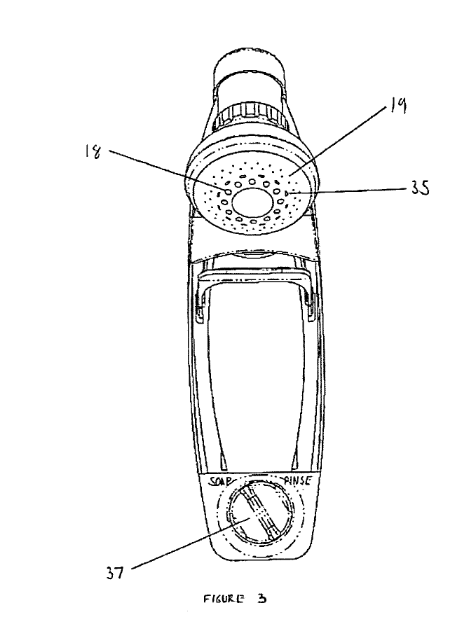

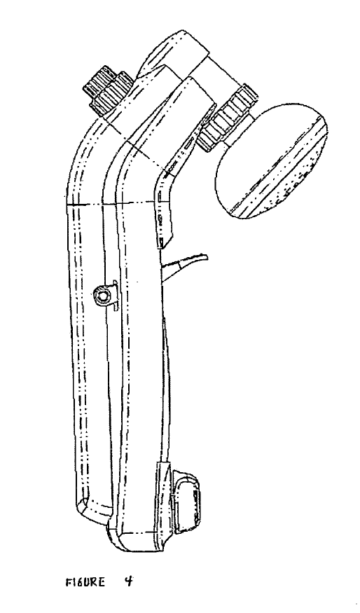

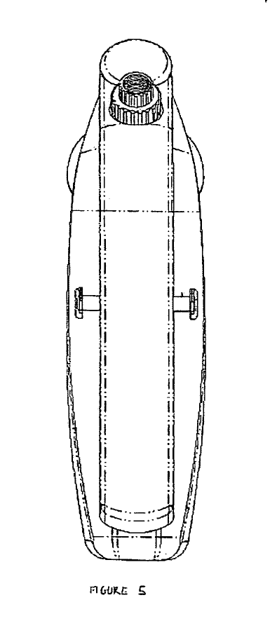

Referring to FIGS. 1-5, a first preferred embodiment of the invention has a pipe fitting 3 having internal threads 2 attaches directly to a shower faucet pipe 1 of the type typically existing in buildings. A fitting ring 5 is rotatably mounted on the pipe fitting 3 and head internal threads 4 so that the fitting ring 5 may be attached to an externally threaded portion 6 of the bottle bracket 7. First and second water conduits 11, 13 are in communication with a diverter valve 9 so that incoming water from the faucet pipe 1 is directed through the first conduit 11 and through the diverter valve 9, and back up through the second conduit 13. The diverter valve 9 is manually operable via a knob 37 and can be positioned to direct water through the second conduit 13 to the soap and water mixing chamber 15 in the pivoting shower head 17. The soap and water mixture stream then exits the shower head 17 through outlet nozzles 18.

Soap, conditioner, lotion or a similar liquid or gel product is located in a bottle 21, which may be a single-use, disposable bottle or a re-usable bottle. The bottle 21 is placed in the bottle bracket and its threaded cap (not shown) is replaced with the pump cap 10 which together with a spring 24 and tube 12 comprises a pump 23 similar to those known in the art on pump action bottles for dispensing liquid soaps and lotions. A manually operable soap lever 25 is pivotally mounted to the bracket 7 and connected via a linkage arm 27 to the pump 23 in order to selectively and manually activate and control function of the pump 23 to deliver soap or product from the bottle 21 into the mixing chamber 15 via a soap conduit 29. An air intake 35 provides air for agitation to generate suds or foaming of the soap and water mixture in the chamber 15, relying on the Bernoulli effect of moving water to draw in air.

When the diverter valve 9 is moved to a second position, water is diverted through a third conduit 31 to a water-only cavity 33, thus bypassing the soap and water mixing chamber 15. This causes water without soap mixed with it to be emitted from the outlet nozzles 19.

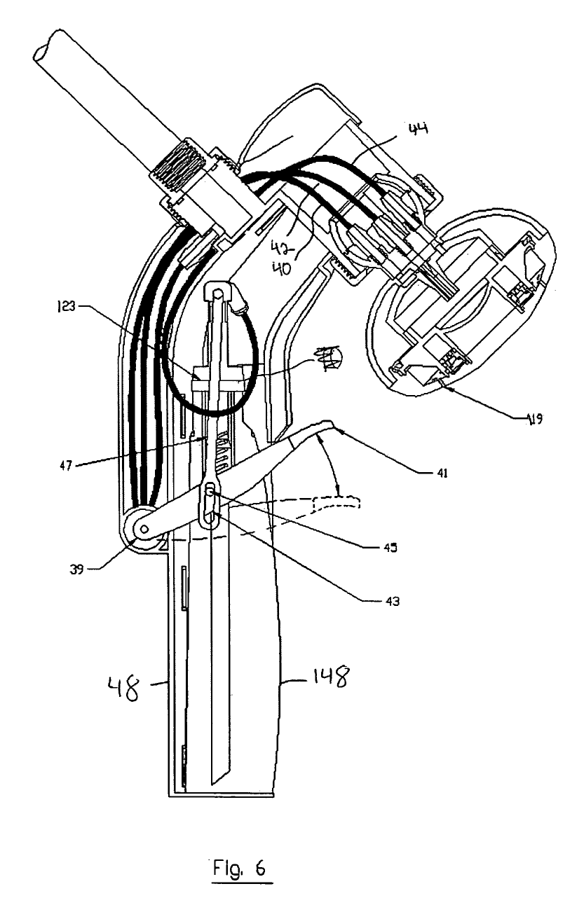

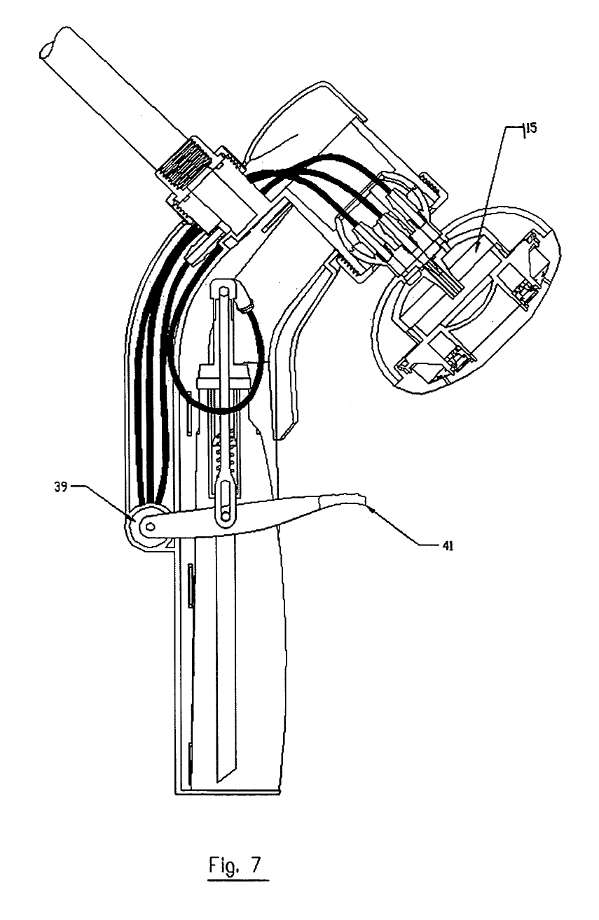

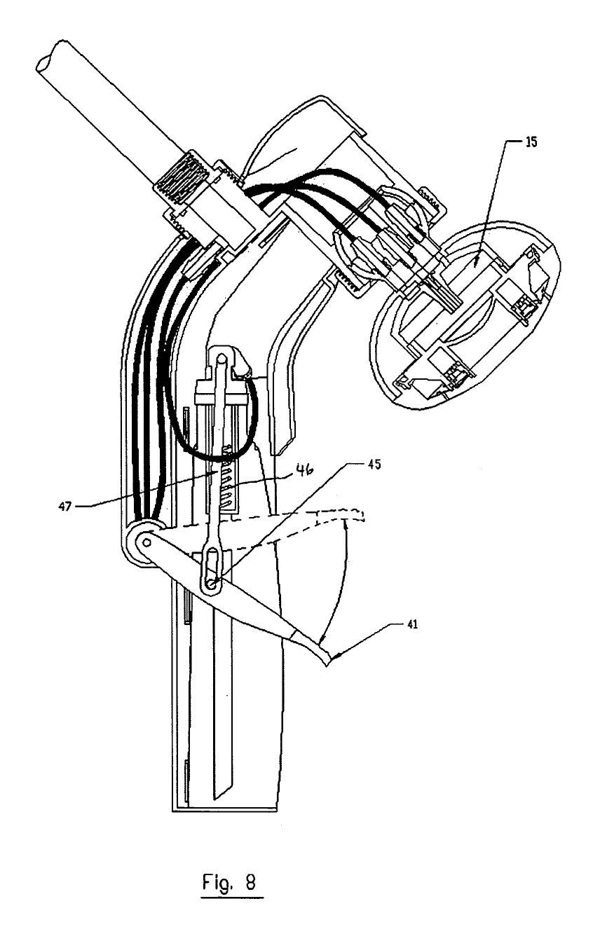

Referring to FIGS. 6-8, a second embodiment includes a diverter valve 39 located in the read of the bottle bracket 48 and operatively connected to a soap dispensing lever 41. The lever 41 causes water only to be emitted from the nozzles 119 when the lever 41 is in the up position shown in FIG. 6 by causing the valve 39 to divert water through a first conduit 40. A slot 43 that received a pin 45 permits movement of the lever 41 upwardly without activating the pump 123. FIG. 7 shows the lever 41 in the center position, which causes the valve 39 to send water through a second conduit 42 to a mixing chamber 115 to mix soap and water. Pulling the lever 41 all the way down as shown in FIG. 8 causes the pin 45 to move the linkage 47 down and activate the pump 123. This causes soap or product contained in the bottle 148 to be delivered into the mixing chamber 115 via a soap conduit 44. The pump spring 46 automatically returns the lever 41 to the up position.

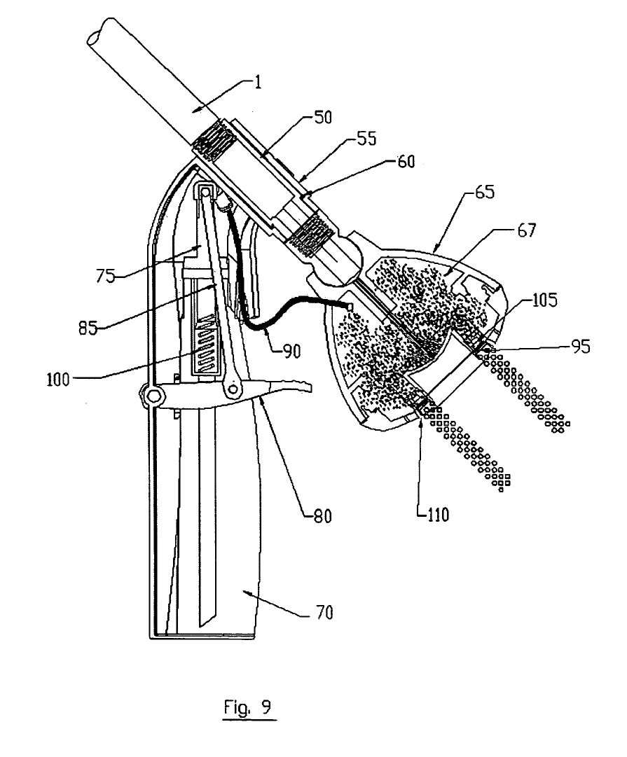

A third embodiment is shown in FIG. 9. A pipe fitting 50 is screwed onto the existing faucet pipe 1. A bottle holding bracket 55 is placed over the fitting 50. A rubber washer or o-ring 60 is placed between a circular step on the fitting 50 and a matching step in the bracket 55. The showerhead 65 is then screwed onto the fitting 50. The clamps the bracket 55 together with the fitting 50. The o-ring 60 provides friction to prevent the assembly from slipping. Water entering from the faucet pipe 1 goes into the soap and water mixing chamber 67. Soap located in a soap bottle 70 is pumped manually via a pump 75 and lever 80, which moves a linkage arm 85 to activate the pump 75. The soap injection hose 90 delivers the soap from the pump 75 to the mixing chamber 67. The soap and water mixture passes through an aeration section 105 where air mixes via an air intake 110 to agitate the mixture and make suds or foam. The intake 110 delivers air via a Bernoulli effect. The water and soap are emitted through the nozzles 95. The soap lever 80 returns to the up position automatically by force from the spring 100.

While the preferred embodiment of the present invention has been disclosed herein, it is understood that various modification can be made without departing from the scope of the presently claimed invention.

What is claimed is:

1. A shower head and soap dispensing assembly adapted to attach to a faucet pipe, said assembly comprising
a pipe fitting adapted to attach to a faucet pipe;
a bottle bracket attached to said pipe fitting and adapted to hold a bottle of soap;
a shower head having a plurality of outlet nozzles;
a soap mixing chamber in fluid communication with at least some of said outlet nozzles;
a first conduit in fluid communication with said faucet pipe to receive water from said faucet pipe;
a diverter valve in fluid communication with said first conduit;
a second conduit in fluid communication with said diverter valve and in fluid communication with at least some of said outlet nozzles;
a third conduit in fluid communication with said diverter valve and in fluid communication with said soap mixing chamber; and
a pump manually operable to selectively pump soap from said bottle into said mixing chamber.

2. An assembly according to claim 1, further comprising
a lever operatively attached to said pump and adapted to be manually activated to operate said pump.

3. A shower head and soap dispensing assembly adapted to attach to a faucet pipe, said assembly comprising
a pipe fitting adapted to attach to a faucet pipe;
a bottle bracket attached to said pipe fitting and adapted to hold a bottle of soap;
a shower head having a plurality of outlet nozzles;
a soap mixing chamber in fluid communication with at least some of said outlet nozzles;
a diverter valve in fluid communication with said first conduit;
a water-only conduit in fluid communication with said diverter valve and in fluid communication with at least some of said outlet nozzles;
a soap-mixture conduit in fluid communication with said diverter valve and in fluid communication with said soap mixing chamber; and
a pump manually operable to selectively pump soap from said bottle into said mixing chamber.
